(19) United States
(12) Patent Application Publication
(10) Pub. No.: US 2003/0065616 A1
(43) Pub. Date: Apr. 3, 2003

(54) Consumer refund deferred provider payment elective tax-deferred savings instrument business method

(76) Inventor: Francis E. O'Donnell JR., Town ?amp; Country, MO (US)

Correspondence Address: Paul M. Denk, 763 South New Ballas Road, St. Louis, MO, 63141, US

(21) Appl. No.: 10/232,876

(22) Filed: Aug. 30, 2002

Related U.S. Application Data
(63) Continuation-in-part of application No. 09/593,498, filed on Jun. 14, 2000.
(60) Provisional application No. 60/139,571, filed on Jun. 16, 1999.

(51) Int. Cl. G06F 17/60

(52) U.S. Cl. 705/39; 705/40

(57) ABSTRACT

A method of purchasing a product or service in which a tax-deferred savings instrument is used to provide for a full or partial refund to the consumer, while also proving a partially deferred or totally deferred payment to the provider of the service or product to the consumer. The method utilizes a computer system executing a computer program which can provide a full definition of the required tax-deferred savings instrument by solving after solving a set of equations which can be used to calculate a number of unknown variables upon the insertion of certain known variables into the computer program.

### CROSS-REFERENCE TO RELATED APPLICATIONS

This application is a continuation-in-part of application Ser. No. 09/593,498, filed Jun. 14, 2000, which claims priority to provisional application Ser. No. 60/139,571, filed Jun. 16, 1999.

### STATEMENT REGARDING FEDERALLY SPONSORED RESEARCH OR DEVELOPMENT

Not applicable.

### BACKGROUND OF THE INVENTION

The present invention concerns a novel business strategy wherein a service can be provided to a consumer with a partial or total refund of the purchase price. As such, the present invention makes it possible to expand access to such services by reducing their long-term economic burden.

Prior art business programs offering a refund have generally been limited to money-back guarantees of satisfaction. In the burial industry, some pre-arrangement plans have featured an annuity wherein the purchaser makes an up-front payment for the purchase of the annuity. The annuity is redeemed upon the death of the purchaser, and the proceeds are used to pay for funeral expenses.

### BRIEF SUMMARY OF THE INVENTION

The present invention resides in a business method that features a total or partial refund of the purchase price to the consumer at the end of the predetermined interval. Moreover, it provides for partial or total deferment of income to the provider of the service. By matching the long-term economic plans of the consumer and the provider, the present invention matches current supply and demand in the marketplace while at the same time providing an attractive financial means of purchasing a product or service. The administrator of the present invention derives part or all of its business income from the earnings surplus left over after the consumer refund and the deferred payment for services to the provider. The business method is expedited by a computer program that determines the amount the purchase price that must be placed in a tax-deferred interest bearing instrument to yield a return to pay the deferred purchase price to the seller and provide a refund to the consumer.

It is an object of the present invention to provide a refund incentive to a consumer. Such a refund incentive will encourage consumers to make purchases of products or services which would otherwise not be considered by the consumer.

It is a further object of the present invention to provide a deferred income program to a provider.

It is still a further object of the present invention to match long-term economic plans of the consumer with those of a provider. Because the net result of the invention can be a partial refund to the consumer with a full payment to the provider of the product or service, the economic considerations of both participants can be met.

Another object of the present invention is to provide a planning tool that can be used to solve a multivariable equation matching the economic needs of the consumer, the provider, and the plan administrator.

### DESCRIPTION OF THE DRAWINGS

FIG. 1 is a diagram depicting the operation of the computer program.

FIG. 2 is an example of a computer screen which may be used to input initial data.

FIG. 3 is a Flow Diagram depicting the execution of the three distinct cases solvable in the present invention.

Appendix A is a sample computer program written to embody the present invention.

### DETAILED DESCRIPTION OF THE INVENTION

The present invention generally provides for a consumer to establish a trust fund for the purposes of purchasing a tax-deferred savings instrument. An administrator serves as trustee for the trust. The beneficiary of the tax-deferred savings instrument is the trust and the beneficiary of the trust is the consumer. The trust enters into a contract for deferred payment of the current service for the consumer to a provider. At a maturity date agreed upon by the consumer and the provider, the trust liquidates the tax-deferred savings instrument. It pays the taxes on the accumulated interest, pays the provider the contracted amount, refunds the contracted amount to the consumer, and it keeps the balance as a trustee fee. The trustee fee covers preparation and administration of the trust, and it includes a profit for the trustee.

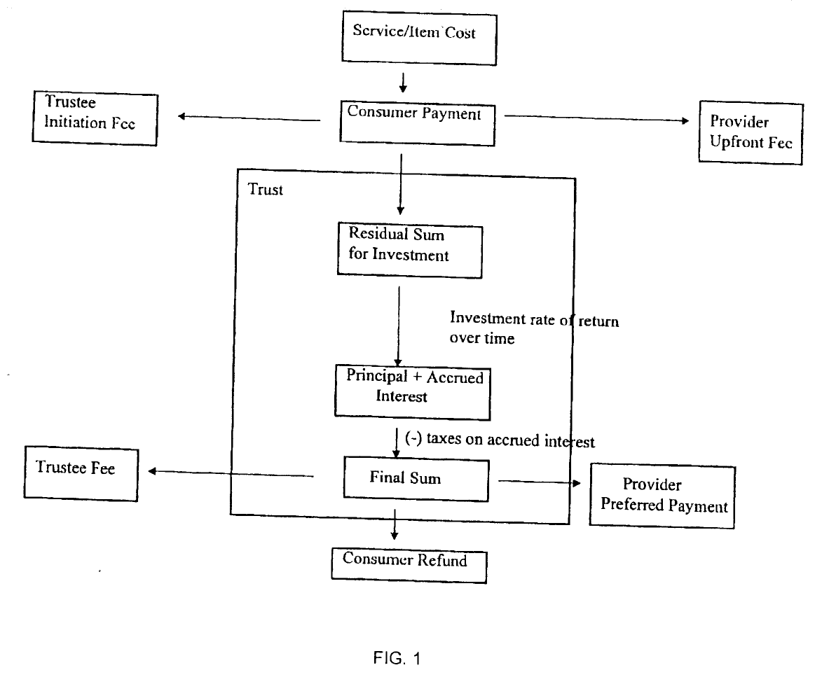

One exemplary embodiment of the present invention is illustrated by the Flow Diagram in FIG. 1, which summarizes how the program operates, although variations on this general flow of program execution are within the scope of the present invention. Referring now to FIG. 1, the procedure (service) and/or capital item cost is generally determined by typical market condition of supply and demand. The amount of money that the consumer must place into the program is determined, in part, by the deduction owing to provider payments up front and to trustee fees paid up front. In addition, the investment's rate of return and the provider's requirement for date of deferred payment (part or all) influences the amount of money placed into the program at the onset. The money is placed into a trust which generally selects a tax advantage investment such as life insurance, tax free municipal bonds, charitable remainder trusts, or an annuity. The trust, under the direction of the trustee, makes the necessary disbursements to pay the provider at the due date and any taxes owed. Contemporaneously or subsequently, the trustee liquidates the trust to disburse the proceeds, after taxes, to the consumer and to the trustee.

In an alternative embodiment, prior to maturation the trustee may sell its rights to a finance company which in turn pools many such contracts and offers long term debt instruments such as no-interest bonds (zero coupon bond) to investors.

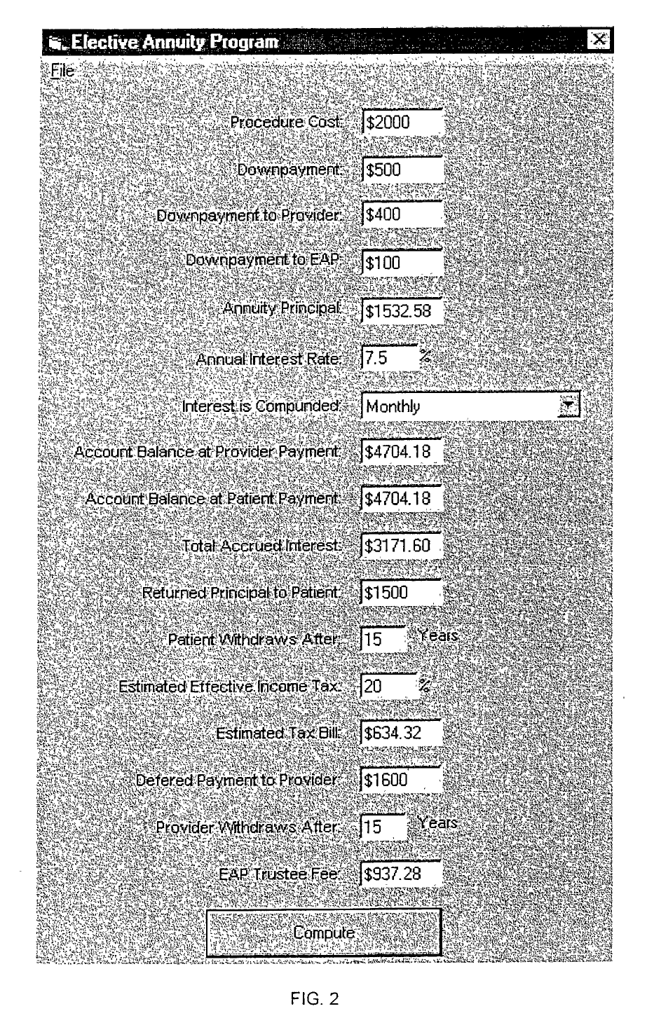

In order to meet the competing financial needs of the consumer, the provider, and the trustee, and in order to allow for differences in the investment rate of returns and taxes, it is desirable to use a multivariate equation to solve for the economic structure of each proposed transaction. The program then generates financial description of the tax- deferred savings instrument that use utilized to successfully fund and perform all aspects of the the business method. This is preferably achieved by the use of a computer system executing a software program. A typical computer input screen is shown in FIG. 2.

As shown in FIG. 2, the procedure or service cost is identified as “Procedure Cost.” In the case of a photorefractive keratectomy (PRK), for example, this might be $2,000.00 per eye, depending upon market conditions (supply and demand). The provider and trustee must decide how much of the fee must be paid around the time of the service and this is identified as the “Downpayment” ($500 in this example). After the provider decides how much he is willing to defer under the program ($1,600.00 in this example), a portion of the Downpayment is allocated to the provider as “Downpayment to Provider” (here, $400) with the remainder allocated as a “Downpayment to EAP”, the elective tax-deferred savings instrument profit (here, $100).

Next, the provider must identify when he is to receive all or part of the deferred payment for services, identified on the sample input screen as “Provider Withdraws After”(15 years in this example). Next, the patient must decide how much they can afford to pay now, knowing that, at maturity, the program is intended to repay part or all of the amount paid by the consumer. The program can then solve for the trustee fees it will receive for the program coordination, legal work, and tax returns for the trust.

In computing the unknown variables, the elective tax-deferred savings instrument program solves unknown variables in the three distinct cases possible under the elective tax-deferred savings instrument program business plan. These three distinct cases are:

Case 1. The consumer withdraws funds before the provider;

Case 2. The provider withdraws funds before the consumer; and

Case 3. The provider and consumer withdraw funds at the same time.

In each of these cases, the program begins in an initial state and then proceeds to perform the required calculation predicated upon which of the above three distinct cases applies. A separate set of equations applies and is solved for each of the three distinct Cases, depending on whether the applicable interest is either compound interest or simple interest.

Initial State: Software Presents Input Fields to User

Because the software is a multi-variable equation solver, the program initially opens with all variables set to 0. An input screen presents the user with input fields corresponding to the following variables:

c=Cost of the Procedure

s=Number in Years Until the Provider Draws Funds

p=Number in Years Until the Consumer Draws Funds

EAP=Elective Tax-Deferred Savings Instrument Profit

i=Interest Rate per Year

A=Initial Amount Placed In the Tax-Deferred Savings Instrument

n=Number of Interest Periods per Year

After entering all known variables (with the remaining variables set to 0 if not input by default), the program determines from the inputs which one of the following three distinct cases is involved. The program then solves the equation defined for that distinct case. Is should be noted that in each of the three distinct cases, the equation used depends on whether the interest is compounded or simple. A different equation is used within each distinct case for either compound or simple interest. In each of the three distinct cases below, once the equation is solved, an output screen displays the solution of the equation and the value of all of the known and unknown variables.

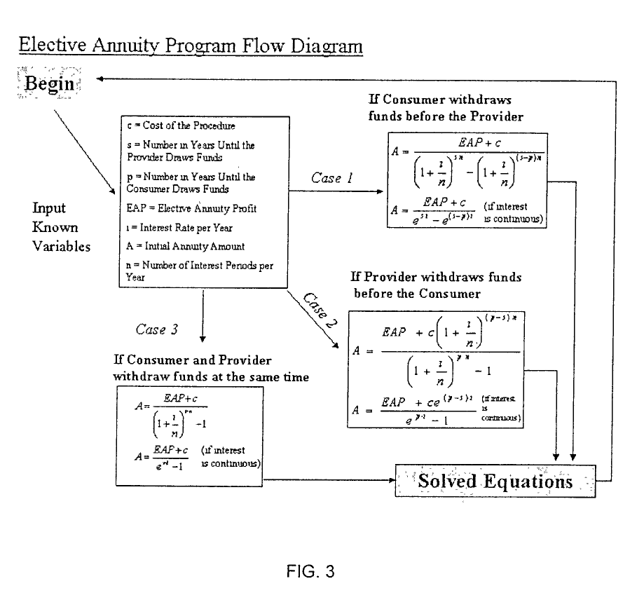

The following description of the elective annuity program is generally depicted in the Flow Diagram of FIG. 3.

Case 1: The Consumer withdraws funds before the Provider.

In this case, the program solves the following equation when the interest is compounded:

$$A = \frac{EAP + c}{{( 1 + \frac{i}{n} )}^{s - n} - {( 1 + \frac{i}{n} )}^{( s - p ) - n}}$$

In this case, the program solves the following equation when the interest is simple:

$$A = \frac{EAP + c}{{ⅇ}^{s - i} - {ⅇ}^{( s - p ) - i}}$$

Case 2: When the Provider Withdraw Funds Before the Consumer.

In this case, the program solves the following equation when the interest is compounded:

$$A = \frac{EAP + {c ( 1 + \frac{i}{n} )}^{( p - s ) - n}}{{( 1 + \frac{i}{n} )}^{p - n} - 1}$$

In this case, the program solves the following equation when the interest is simple:

$$A = \frac{EAP + {ce}^{( p - s ) - i}}{{ⅇ}^{p - i} - 1}$$

Case 3: When Consumer and Provider Withdraw Funds at the Same Time.

In this case, the program solves the following equation when the interest is compounded:

$$A = \frac{EAP + c}{{( 1 + \frac{i}{n} )}^{s - n} - 1}$$

In this case, the program solves the following equation when the interest is simple:

$$A = \frac{EAP + c}{{ⅇ}^{s - i} - 1}$$

In the preferred embodiment, all of the above calculations are performed during the execution of a computer program on a computer system. A typical computer program is included as Appendix A. Other methods of generating the description of the tax-deferred savings instrument may be used without departing from the scope of the invention.

Therefore, as various other changes could be made in the above embodiments without departing from the scope of the invention, it is intended that all matter contained in the above description or shown in the accompanying drawings shall be interpreted as illustrative and not in a limiting sense.

In view of the above, it will be seen that the several objects and advantages of the present invention have been achieved and other advantageous results have been obtained.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of procuring a service or product comprising:
determining a price of a product or a service provided to a consumer by a provider;
determining a payment portion of the determined price of the product or service that must be placed in an interest bearing tax-deferred savings instrument by the consumer to pay the predetermined price and produce return from the tax-deferred savings instrument in excess of the predetermined price of the product or service;
placing the determined payment portion of the predetermined price of the product or service in a trust fund;
purchasing a tax-deferred savings instrument by the trust fund with the payment payment portion;
collecting return from the tax-deferred savings instrument in the trust fund; and
utilizing the return from the tax-deferred savings instrument to pay the price of the product or the service.

2. The method of claim 1 further comprising the step of utilizing a computer system executing a computer program designed to perform a set of calculations necessary to derive a value for each of a set of variables used to determine a financial description for the tax-deferred savings instrument to accomplish the method.

3. The method of claim 1 further comprising utilizing the return from the tax-deferred savings instrument to provide a partial refund or a complete refund to the consumer for the portion of the price paid for the product or the service.

4. The method claim 1 further comprising utilizing the return from the tax-deferred savings instrument to provide a deferred partial payment or a deferred total payment to the provider of the price paid for the product or service.

5. The method of claim 1 further wherein the tax-deferred savings instrument is selected from a group consisting of a life insurance policy, tax free municipal bonds, a charitable remainder trust, or an annuity.

6. The method of claim 1 wherein the beneficiary of the tax-deferred savings instrument is the trust fund.

7. The method of claim I wherein the beneficiary of the trust fund is the consumer.

8. The method of claim 4 wherein a contract is formed between the trust fund and the provider for a deferred partial payment or a deferred total payment to the provider for the purchase of the product or the service by the consumer.

9. The method of claim 1 further comprising liquidating the trust fund at a specified maturity date wherein the liquidation generates an asset balance which is disbursed to pay: (a) a tax on the accumulated interest of the trust, (b) the provider for the product or service provided to the consumer, and (c) a refund to the consumer of the purchase price of the product or service purchased by the consumer, wherein any remaining asset balance paid to the administrator of the trust fund as a trustee fee.

10. The method of claim 2 wherein the computer program calculates the financial description of the tax-deferred savings instrument in anticipation of the consumer withdrawing funds from the tax-deferred savings instrument before the provider withdraws funds from the tax-deferred savings instrument.

11. The method of claim 10 wherein the computer program calculates the financial description of the tax-deferred savings instrument when interest from the tax-deferred savings instrument is compounded interest by solving the following equation:
$$A = \frac{EAP + c}{{( 1 + \frac{i}{n} )}^{s - n} - {( 1 + \frac{i}{n} )}^{( s - p ) - n}}$$

12. The method of claim 10 wherein the program calculates the financial description of the tax-deferred savings instrument when interest from the tax-deferred savings instrument is simple interest by solving the following equation:
$$A = \frac{EAP + c}{{ⅇ}^{s - i} - {ⅇ}^{( s - p ) - i}}$$

13. The method of claim 2 wherein the computer program calculates the financial description of the tax-deferred savings instrument in anticipation of the provider withdrawing funds from the tax-deferred savings instrument before the consumer withdraws funds from the tax-deferred savings instrument.

14. The method of claim 13 wherein the program calculates the financial description of the tax-deferred savings instrument when interest from the tax-deferred savings instrument is compounded interest by solving the following equation:
$$A = \frac{EAP + {c ( 1 + \frac{i}{n} )}^{( p - s ) - n}}{{( 1 + \frac{i}{n} )}^{p - n} - 1}$$

15. The method of claim 13 wherein the program calculates the financial description of the tax-deferred savings instrument when interest from the tax-deferred savings instrument is simple interest by solving the following equation:
$$A = \frac{EAP + {ce}^{( p - s ) - i}}{{ⅇ}^{p - i} - 1}$$

16. The method of claim 2 wherein the computer program calculates the financial description of the tax-deferred savings instrument in anticipation of the consumer withdrawing funds from the tax-deferred savings instrument at the same time the provider withdraws funds from the tax-deferred savings instrument.

17. The method of claim 16 wherein the program calculates the financial description of the tax-deferred savings instrument when interest from the tax-deferred savings instrument is compounded interest by solving the following equation:
$$A = \frac{EAP + c}{{( 1 + \frac{i}{n} )}^{s - n} - 1}$$

18. The method of claim 16 wherein the program calculates the financial description of the tax-deferred savings instrument when interest from the tax-deferred savings instrument is simple interest by solving the following equation:
$$A = \frac{EAP + c}{{e}^{s - i} - 1}$$

19. The method of claim 2 wherein a computer system displays an input screen utilized for inputting values of a set of values for a known set of variables and wherein the computer system displays an output screen which shows the values of the known set of variables and a set of values for an unknown set of variables as calculated by the computer system using a computer program.
